(19) United States
(12) Patent Application Publication
(10) Pub. No.: US 2019/0114579 A1
(43) Pub. Date: Apr. 18, 2019

(54) ACCESSING PIPE IDENTIFICATION AND TRACKING SYSTEM

(71) Applicant: Ultra Premium Services, L.L.C., Houston, TX (US)

(72) Inventors: Christopher Tu Tran, Houston, TX (US); Curtis Matthew Potts, Regina (CA)

(73) Assignee: Ultra Premium Services, L.L.C., Houston, TX (US)

(21) Appl. No.: 16/163,050

(22) Filed: Oct. 17, 2018

Related U.S. Application Data
(60) Provisional application No. 62/573,490, filed on Oct. 17, 2017.

(51) Int. Cl. G06Q 10/08; G06F 16/248; G06K 7/10

(52) U.S. Cl. CPC G06Q 10/087; G06K 7/10297; G06F 16/248

(57) ABSTRACT

Techniques include systems and methods for accessing an identification and tracking system for tubular goods. One or more embodiments involve reading an identifier of a pipe, sending a query to a database to access pipe information associated with the identifier, and displaying pipe information based on the identifier, in response to the query. In some embodiments, reading the identifier includes reading an RFID tag on the pipe and displaying pipe information which may comprise pipe dimensions, pipe composition, pipe treatment details, pipe testing results, pipe order number, bill of lading number, pipe manufacturing location, pipe treatment location, pipe delivery destination, or combinations thereof.

### TECHNICAL FIELD

The present application relates to tracking systems, and more particularly, to identification and tracking systems for tubular goods.

### BACKGROUND

This section is intended to introduce various aspects of art that may be related to various aspects of the present techniques, which are described and/or claimed below. This discussion is believed to be helpful in providing background information to facilitate a better understanding of the various aspects of the present disclosure. Accordingly, it should be understood that these statements are to be read in this light, and not as admissions of prior art. The following descriptions and examples are not admitted to be prior art by virtue of their inclusion in this section.

The oil and gas industry is drilling upstream production wells of increasing depth and complexity to find and produce raw hydrocarbons. The industry routinely uses steel pipe, considered an Oil Country Tubular Good (OCTG) to protect the borehole (i.e., casing) and to control the fluids produced within the pipe (i.e., tubing). Such tubular goods, including casing and tubing, are made and transported in relatively short segments and installed in the borehole one segment at a time, with each segment being connected to the next.

Depending on the different environments of a borehole, conditions for production, and other demands of a customer, various types of pipe may be ordered and transported. Additionally, large quantities of pipe may be needed for relatively deeper wells. The large quantity and variety of tubular goods may result in logistical challenges in the OCTG industry. For example, manufacturers, distributors, and end users may all benefit from more efficient techniques for identifying and tracking pipe. Systems for efficiently identifying various attributes of a segment of pipe, and tracking its source, location, and destination may be developed to meet industry demands.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one embodiment, an identification and tracking system includes a non-transitory tangible computer-readable storage medium having executable computer code stored thereon, the code comprising instructions that causes one or more processors to store a database comprising a plurality of pipe IDs and pipe information concerning one or more characteristics of the specific pipe, receive a query comprising a pipe ID, locate pipe information associated with the query, and display the pipe information.

In some embodiments, the pipe information includes pipe dimensions, pipe composition, pipe treatment details, pipe testing results, pipe order number, bill of lading number, pipe manufacturing location, pipe treatment location, pipe delivery destination, or combinations thereof. The system is configured to accept one or more identifiers each specific to a different pipe and display one or more pipe IDs, each associated with one of the one or more identifiers. The system may further include a scanner configured to communicate with the one or more processors and configured to scan the identifier of a pipe. Additionally, one or more of the processors may be configured to access the pipe ID from a remote database.

In another embodiment, a method includes reading an identifier of a pipe, sending a query to a database to access pipe information associated with the identifier, and displaying pipe information based on the identifier, in response to the query.

In some embodiments, reading the identifier includes reading an RFID tag on the pipe and displaying pipe information comprises displaying pipe dimensions, pipe composition, pipe treatment details, pipe testing results, pipe order number, bill of lading number, pipe manufacturing location, pipe treatment location, pipe delivery destination, or combinations thereof.

### BRIEF DESCRIPTION OF THE DRAWINGS

Embodiments of the present techniques are described with reference to the following figures. The same numbers are used throughout the figures to reference like features and components. Various embodiments may utilize elements and/or components other than those illustrated in the drawings, and some elements and/or components may not be present in various embodiments. Elements and/or components in the figures are not necessarily drawn to scale.

FIG. 1 is a schematic diagram of a tubular goods identification and tracking system;

FIG. 2 is a block diagram representing a method for implementing a system for identifying and tracking tubular goods;

FIG. 3 is another block diagram representing a method for accessing information and tracking tubular goods using the system;

FIG. 4 is a screenshot of a web application integrated with embodiments of the present techniques; and

FIGS. 5A and 5B are screenshots of a mobile application integrated with embodiments of the present techniques.

### DETAILED DESCRIPTION

A large quantity and variety of tubular goods are produced, sold, and used in many industries, such as oil and gas, construction, water transport, automotive, agricultural, fluid power industries, etc. Identifying and tracking tubular goods throughout their manufacture, quality testing, shipment, and use may result in increased efficiencies and more accurate inventory control for manufacturers, deliverers, distributors, and end users of tubular goods. Tubular goods may refer to tubing, casing, drill pipe, line pipe, other OCTG products or American Society for Testing and Materials (ASTM) products, hollow structural sections (HSS), etc., and may be referred to as simply “pipe.” Tubular goods or pipe may include any tubular metal having a hollow cross section.

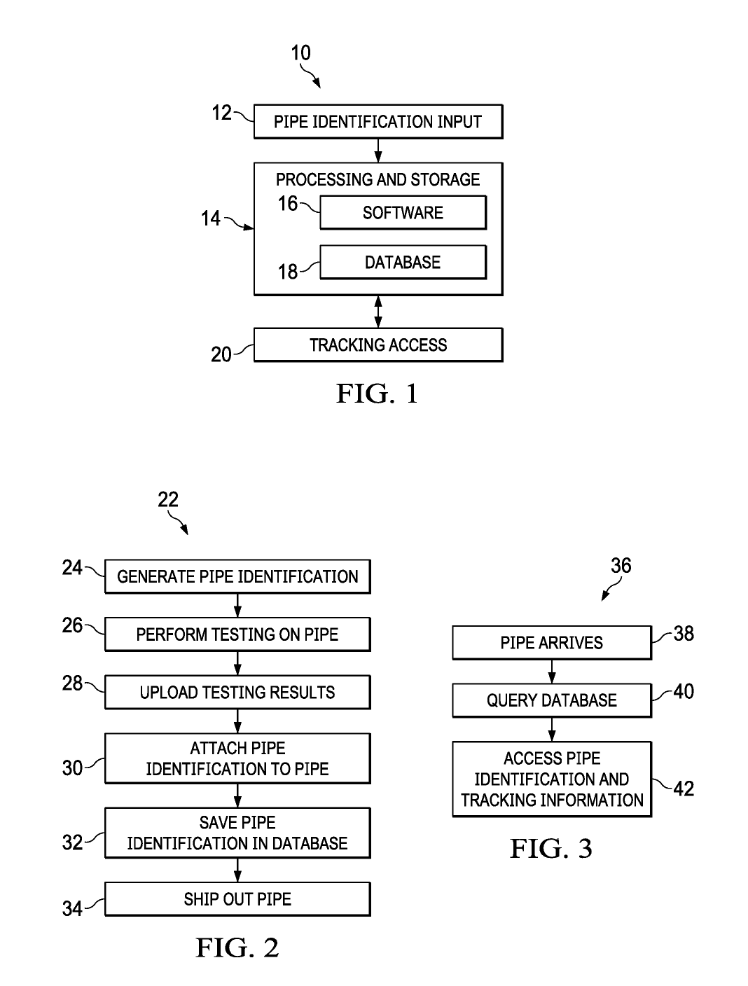

The schematic diagram of FIG. 1 includes components which may be used in a system for identifying and tracking tubular goods. The system 10 includes means for inputting (block 12) of pipe identification information. For example, pipe identification information may include a pipe serial number, a batch number, any associated sales order number, a location in which it was manufactured, tested, and/or treated, dimension information such as length, diameter, weight, material, and any other relevant information on the characteristics of the pipe. Pipe identification information may also include historical information about the pipe, such as its date of manufacture and shipment, and intermediate shipment or treatment destinations. Pipe identification information may be input into system 10 using a graphical user interface (GUI) on a general purpose computer, a specially adapted terminal, or other similar means.

The pipe identification information may be input to the processing and storage system 14. The processing and storage system 14 may include software 16 for processing and organizing the pipe identification information and storing it into a database 18.

The pipe identification information may then be accessed (block 20) from the database 18. For example, once the pipe reaches its destination, a distributor or end user may use a scanner or reader to scan or read an external identifier of a pipe. In some embodiments, the identifier may include a barcode, a radio-frequency identification (RFID), QR code, or any unique external identifier. The scanner or other device used to read the external identifier may be in communication with a remotely located processor used to store database 18. Such communication may be via a direct connection or wireless, such as using wi-fi or Bluetooth technology. Alternatively, mobile devices may be adapted such that scanning or reading the identifier may provide immediate access to pipe identification information of the scanned pipe. For example, an application or web portal may be saved on a mobile phone or laptop which may display the associated pipe identification information once a pipe is scanned.

The block diagrams in FIGS. 2 and 3 provide more details of the pipe identification and tracking techniques of this disclosure. FIG. 2 is a block diagram representing a method 22 for implementing a system for identifying and tracking tubular goods as they are manufactured. The method 22 begins with generating (block 24) a pipe identification (pipe ID) for a particular length of pipe. Generating (block 24) the pipe ID may occur while or around when the pipe is manufactured. The pipe ID may initially include a pipe serial number, a batch or work order number, a pipe type, and/or the name of the plant in which the pipe has been manufactured. As the pipe is manufactured, a barcode or other unique external identifier may also be stenciled on the pipe. The external identifier may be used to identify a particular pipe to its assigned pipe ID. In some embodiments, stenciled barcode may primarily be used to identify a pipe during the manufacturing process, such that more information about the pipe may be properly input to the pipe's pipe ID.

Once a pipe has been manufactured and a pipe ID has been generated (block 24) for the pipe, various tests may be performed (block 26) on the pipe. For example, the pipe may undergo a hydrotester to test its performance under water pressure. Non-destructive testing (e.g., electromagnetic, ultrasonic, etc.) may also be performed to further assess the pipe's characteristics and quality and test it for defects. The results of this testing (block 26) may be added (block 28) to information associated with the pipe ID.

If the pipe has the appropriate characteristics to pass the testing (block 26), an external identifier linked to the pipe ID may be attached (block 30) to the pipe. In some embodiments, this identifier may be etched as a barcode, QR code, RFID tag, or other unique external identifier which may be adhered to an inner diameter or a thread protector of a pipe. The identifier may be suitable for remaining affixed to the pipe and functional through testing, coating, treating, and/or shipping of the pipe. For example, in some embodiments, a heat-resistant RFID tag may be adhered to the pipe.

Once the identifier is attached (block 30) to the pipe, the pipe ID may be saved (block 32) in a database (e.g., database 18 from FIG. 1). In some embodiments, the pipe ID may be saved to a database that is designated to store pipe ID and accessible to external requests for pipe information.

When a pipe is shipped (block 34) out of the manufacturing site, the identifier may be scanned to update the location of the pipe. For example, a scanner may be used to scan the RFID tag of a pipe to identify the pipe and update its pipe ID to include information about when the pipe has shipped out of a site, and where the pipe is destined to be delivered.

FIG. 3 is another block diagram representing a method 36 for accessing information and tracking tubular goods using the system. After a pipe is shipped (block 34) out of one location, it may arrive (block 38) at another. In some embodiments, a recipient of the pipe may query (block 40) the database 18 by reading or scanning the identifier on the pipe. A recipient may use an application or web portal from a computer, such as a mobile phone or laptop, which may be integrated with a scanner used to scan the pipe. Scanning the pipe may then allow a recipient to access pipe identification information and tracking information from the database 18, through the recipient's computer.

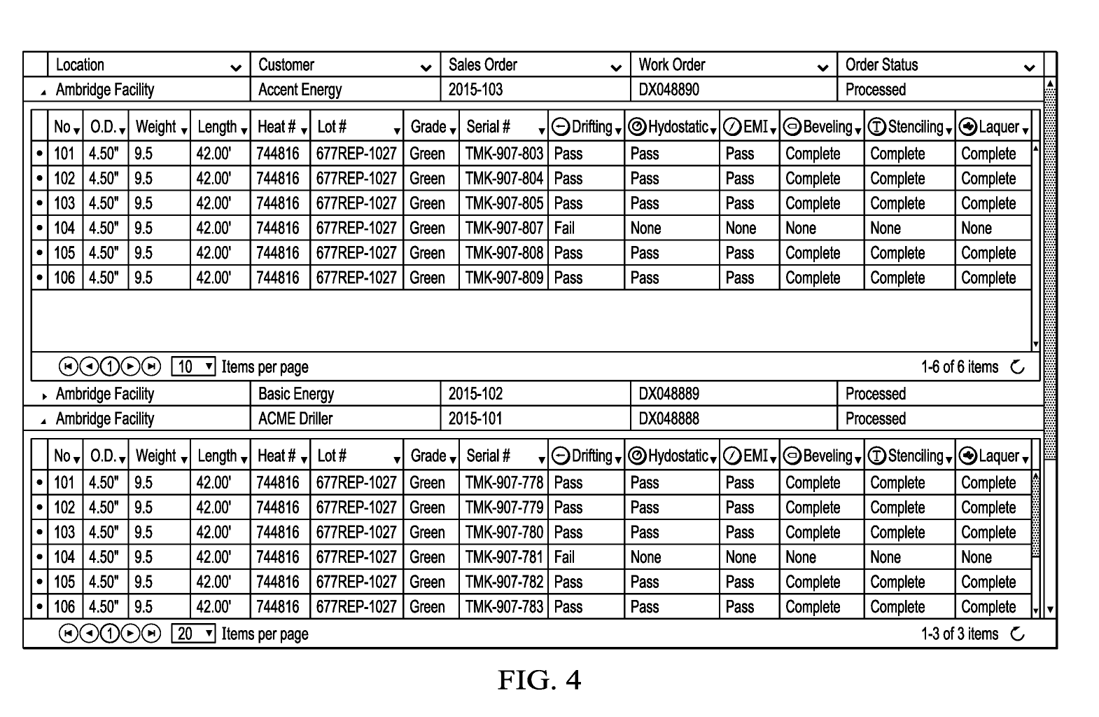

FIG. 4 is a screenshot of an example of a web application integrated with a system for identifying and tracking tubular goods. Several pipes may be scanned or read and simultaneously displayed with organized identification and historical information for each pipe.

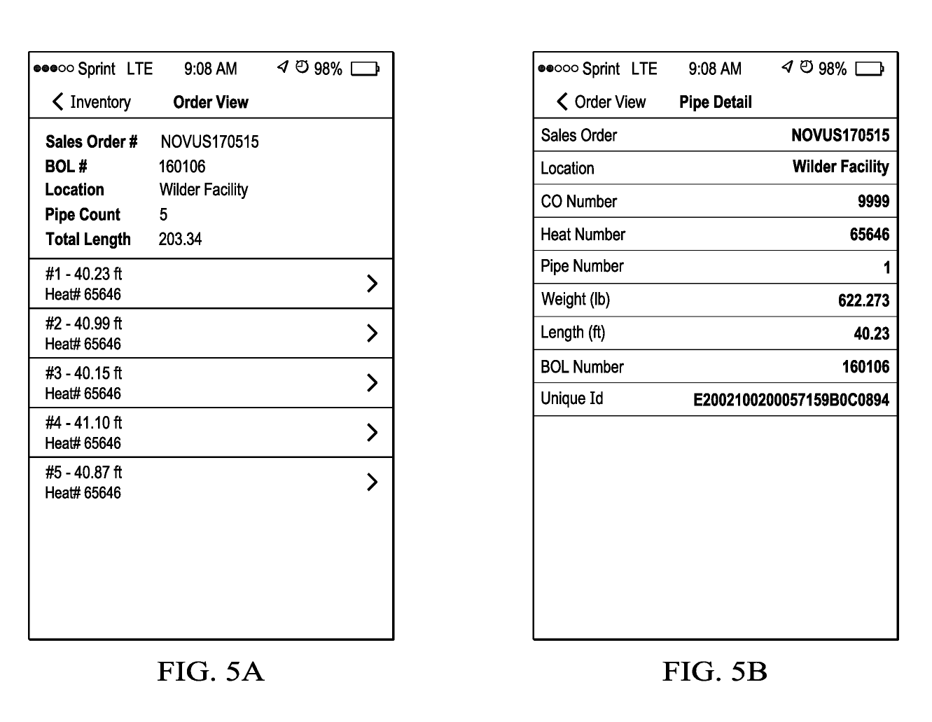

FIGS. 5A and 5B are screenshots of a mobile application integrated with the present embodiments. As shown in FIG. 5A, in some embodiments, the pipe ID for several pipes may be displayed with adjustable levels of detail. Further information may also be displayed in detail for each pipe, as shown in FIG. 5B.

The web application and mobile application may each provide some combination of a number of characteristics associated with a pipe ID of each pipe. In some embodiments, the dimensions (length, weight, inner and/or outer diameters), processing data, testing data, heat treatment information, coil data (including material and composition of the pipe) may be displayed. Information related to the pipe's bill of lading (BOL) number, order number, and manufacturing and/or treatment locations and dates may be displayed.

Many modifications and other implementations set forth herein will be apparent having the benefit of the teachings presented in the foregoing descriptions and the associated drawings. Therefore, it is to be understood that the systems and methods described herein are not to be limited to the specific implementations disclosed and that modifications and other implementations are intended to be included within the scope of the appended claims. Although specific terms are employed herein, they are used in a generic and descriptive sense and not for purposes of limitation.

1. A system comprising:
a non-transitory tangible computer-readable storage medium having executable computer code stored thereon, the code comprising instructions that causes one or more processors to perform the following:
store a database comprising:
a plurality of pipe IDs, each pipe ID comprising an identifier unique to a specific pipe; and
for each pipe ID, pipe information concerning one or more characteristics of the specific pipe;
receive a query comprising a pipe ID;
within the database, locate pipe information associated with the query; and
display said pipe information.

2. The system of claim 1, wherein the pipe information comprises pipe dimensions, pipe composition, pipe treatment details, pipe testing results, pipe order number, bill of lading number, pipe manufacturing location, pipe treatment location, pipe delivery destination, or combinations thereof.

3. The system of claim 1, further comprising a scanner configured to communicate with the one or more processors and configured to scan a pipe ID.

4. The system of claim 1, wherein the one or more processors is configured to access the pipe ID from a remote database.

5. A method comprising:
reading an identifier of a pipe;
sending a query to a database to access pipe information associated with the identifier; and
displaying pipe information based on the identifier, in response to the query.

6. The method of claim 5, wherein the step of reading the identifier comprises reading an RFID tag on the pipe.

7. The method of claim 5, wherein displaying pipe information comprises displaying pipe dimensions, pipe composition, pipe treatment details, pipe testing results, pipe order number, bill of lading number, pipe manufacturing location, pipe treatment location, pipe delivery destination, or combinations thereof.
